(19) United States
(12) Patent Application Publication
(10) Pub. No.: US 2019/0222604 A1
(43) Pub. Date: Jul. 18, 2019

(54) METHOD AND APPARATUS FOR MEASURING AND PREDICTING THREAT RESPONSIVENESS

(71) Applicants: Vimal Vaidya, Fremont, CA (US); Shray Vaidya, Fremont, CA (US)

(72) Inventors: Vimal Vaidya, Fremont, CA (US); Shray Vaidya, Fremont, CA (US)

(21) Appl. No.: 16/247,412

(22) Filed: Jan. 14, 2019

Related U.S. Application Data
(60) Provisional application No. 62/617,149, filed on Jan. 12, 2018.
(60) Provisional application No. 62/624,775, filed on Jan. 31, 2018.

(51) Int. Cl. H04L 29/06

(52) U.S. Cl. CPC H04L 63/1433; H04L 63/1416

(57) ABSTRACT

Methods, apparatus, and software are provided for utilizing result data generated by various security evaluation and testing methods in measuring and quantifying responsiveness of IT security in fixing issues found by such evaluation and testing. Security evaluation results for two successive evaluation periods are obtained including a current data set and a last data set, wherein each of data set including entries designating respective attacks or tests and a breached or blocked result for that attack or test. The entries are normalized such that each entry in the current and last data set has a unique identifier. The entries in the current and last data sets are then compared based on the respective attack or test designated for associated entries in the current last data sets to determine differences in breached and blocked results for the two successive evaluation periods. An IT responsiveness score in then calculated as a function of the differences that are determined.

### CROSS-REFERENCE TO RELATED APPLICATIONS

The present application claims priority to U.S. Provisional Application No. 62,617/149 filed on Jan. 12, 2018, entitled “METHOD AND APPARATUS FOR MEASURING AND PREDICTING THREAT RESPONSIVENESS (OF IT SECURITY),” and to U.S. Provisional Application No. 62/624,775 filed on Jan. 31, 2018, entitled “METHOD AND SYSTEM FOR STATEFUL MULTI ATTACK SIMULATION,” the disclosures of which are hereby incorporated herein by reference in their entirety for all purposes.

### FIELD OF THE INVENTION

The field of invention relates generally to measuring and IT security team's responsiveness in fixing security issues and, more specifically but not exclusively relates measuring and over a period of time predicting an IT Security team's responsiveness in fixing threats, weaknesses, breach-scenarios, vulnerabilities and other issues found during periodic security evaluation and testing.

### BACKGROUND INFORMATION

Traditionally, there are various ways an enterprise's security infrastructure is evaluated. The term security infrastructure typically includes deployed security solutions in a company's internal and external networks, servers, and endpoints, as well as network components, servers, applications, endpoints, other devices and software. The security infrastructure of testing and evaluation methods may include internally or externally performed vulnerability scanning, penetration-testing, ethical hacking, red-team versus blue-team exercises and any other method of testing and evaluating the security of the deployed servers, application, networks and endpoints. These and other similar testing methods identify potential areas of weaknesses, attack-surface, threat scenarios and other types of vulnerabilities in security infrastructure of a company. Once these issues are found, it is typically the responsibility of IT (information technology) teams (especially an IT security team, if one exists) to fix these identified issues.

Measuring or quantifying performance of an IT security team in fixing issues as they are found helps ensure that a company's security posture remains strong at any given time. It also helps in evaluating the performance of IT security personnel, as well as for planning IT security testing schedules, allocated resources, budgeting, and other relevant details.

For IT management staff including CFOs, CIOs, CIOSs and other management personnel, as well as for customers of a company and external vendors providing services to a company such as Cyber insurance providers and third-party vendors, it is important to understand how the IT organization of a company is responding to threats and other issues found during various types of security testing. According, there is a need for measuring and quantifying responsiveness of fixing security issues within a company to understand potential exposure risk, improve security policy life cycle, building historical performance matrix of IT security as well as to improve overall IT security infrastructure.

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying drawings, wherein like reference numerals refer to like parts throughout the various views unless otherwise specified:

FIG. 1a is a block diagram illustrating a first security testing scheme where one system acts as an attacker, tester or scanner, while another system on the same local network acts as a target;

FIG. 1b is a block diagram illustrating a second security testing scheme under which the attacker/tester/scanner system or human utilizing the attacker/tester/scanner system remotely interacts with a target via a wide area network such as the Internet to perform security testing and/or evaluation;

FIG. 2 illustrates a first exemplary deployment of various attacker/tester/scanner systems and various targets in a company network across some or all of the company's different security zones, wherein the attackers/scanners/testers and various targets are all on company's own network;

FIG. 3 illustrates a second exemplary deployment of various attacker/tester/scanner systems and various targets in a company network across some or all of the company's different security zones, wherein an attacker/tester/scanner can be on the company's network or accessed remotely over the Internet;

FIG. 4 is a schematic diagram illustrating components of an attack template and classifications, according to one embodiment;

FIG. 5 is a block diagram illustrating input and output of the decision tree compiler according to one embodiment;

FIG. 6 illustrates a block diagram of the stateful, dynamic, decision tree driven attack simulation engine according to one embodiment;

FIG. 7 is a block diagram of the components of the decision tree driven attack simulation engine according to one embodiment;

FIG. 8 is the flowchart illustrating the high-level flow of the main program utilizing timer driven events to fork and run multiple instances of decision tree driven attack simulation engine (DTSE) according to one embodiment;

FIG. 9 is a flowchart illustrating operations and logic for implementing a decision tree compiler, according to one embodiment;

FIG. 10 is a continuation flowchart illustrating operations and logic for implementing a decision tree compiler, according to one embodiment;

FIG. 11 is a flowchart illustrating operations of a decision tree driven engine thread started by the main process, according to one embodiment;

FIG. 12 is a flowchart illustrating operations of a timer handler called from main process to handle timer driven events, according to one embodiment;

FIG. 13 is a flowchart illustrating operations of an update handler called from main process to handle updates to the configuration database, according to one embodiment;

FIG. 14 shows a flow diagram illustrating input, output, and processing operations performed by a normalizer and threat responsiveness calculator according to one embodiment;

FIG. 15 is a combined block and flow diagram illustrating further details of the threat responsiveness calculator of FIG. 5;

FIG. 16 is a flowchart illustrating the high-level logical flow of the main program, according to one embodiment;

FIG. 17 is a flowchart illustrating operations and logic for implementing a normalization procedure, according to one embodiment;

FIG. 18 is a flowchart illustrating operations and logic for calculating a threat responsiveness score, according to one embodiment;

FIG. 19 is a flowchart illustrating operations corresponding to a procedure to predict a threat responsiveness score for a future time based on historical data of a set of threat responsiveness scores and their corresponding time of calculation, according to one embodiment;

FIG. 20a is a frontal isometric view of an exemplary blade server chassis in which a plurality of server blades is installed;

FIG. 20b is a rear isometric view of the blade server chassis of FIG. 11a;

FIG. 20c is an isometric frontal view of an exemplary blade server rack in which a plurality of rack-mounted blade server chassis corresponding to FIGS. 11a and 11b are installed; and

FIG. 21 shows details of the components of a typical server blade, according to one embodiment.

### DETAILED DESCRIPTION

Techniques for measuring IT security teams' responsiveness, and associated methods, apparatus, and software are described herein. In the following description, numerous specific details are set forth to provide a thorough understanding of embodiments of the invention. One skilled in the relevant art will recognize, however, that the invention can be practiced without one or more of the specific details, or with other methods, components, materials, etc. In other instances, well-known structures, materials, or operations are not shown or described in detail to avoid obscuring aspects of the invention.

Reference throughout this specification to “one embodiment” or “an embodiment” means that a particular feature, structure, or characteristic described in connection with the embodiment is included in at least one embodiment of the present invention. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

For clarity, individual components in the Figures herein may also be referred to by their labels in the Figures, rather than by a particular reference number. Additionally, reference numbers referring to a particular type of component (as opposed to a particular component) may be shown with a reference number followed by “(typ)” meaning “typical.” It will be understood that the configuration of these components will be typical of similar components that may exist but are not shown in the drawing Figures for simplicity and clarity or otherwise similar components that are not labeled with separate reference numbers. Conversely, “(typ)” is not to be construed as meaning the component, element, etc. is typically used for its disclosed function, implement, purpose, etc.

The method and the system according to one or more embodiments of this invention centers around the innovative concept of first potentially normalizing and then comparing results obtained during a particular type of testing conducted in two successive periods. Various types of security testing and evaluation methods yield different results.

In fact, if two different external penetration-testing consultants are brought in to perform similar type of testing, it is very likely that the resulting report from the two could vary substantially. Same way various security testing, evaluation and scanning solutions generate different results. This makes it very difficult for IT security teams to interpret results generated by various testing methods. Therefore, creating at least a unified way to interpret results would help improving IT efficiency. There are a few standardized ways to identify potential security threats and breach scenarios such as Common Vulnerabilities and Exposure (CVE) scoring system published by MITRE under guidance from a governing body called CNA. CVE is the most common way of identifying a potential vulnerability in security infrastructure. However, while it works very well for vulnerability scanner, penetration testing and other actual attack generation methods go well-beyond just scanning for specific software or system vulnerability. In these cases, CVE may or may not provide a reference threat identifier.

In one embodiment of the present invention, configuration and results for a specific type of security testing, are first normalized. In one embodiment, such normalization requires assigning a unique threat identifier to be assigned to a specific threat being tested or evaluated. The unique threat or attack identifier could be a generated using a combination of threat description, specific application software, system or other targeted entity and possibly the severity of impact on the target system of such attack or threat.

In another embodiment, if a CVE type of reference identifier is already present for each threat being tested or evaluated, then such existing identifier is used. In yet another embodiment, a vendor or product specific normalization is used if such a vendor or product provides specific threat identifier for each of the threat or attack being generated by the vendor or product during the testing.

In one embodiment, normalization is done for both configuration database and results before tests are performed. In one embodiment, normalization is done after the tests are performed. In another embodiment, no normalization is performed either before or after tests are performed.

In one embodiment normalization also includes normalizing the results to specifically identify if the specific threat has either successfully breached or has been blocked by denoting results as such i.e., “Breached” vs “Blocked”

In an embodiment of the present invention once normalization is performed, two successive test results performed through either the same security testing product, security testing method or vendor are compared to find the “difference” between the two such successive test results, called “last” and “current” results.

In one embodiment, Breached tests from each result are compared to find how many of them are the same between the last and current results. In one embodiment, the Blocked tests are compared.

In one embodiment, the number of current breached results that are different from last results are subtracted from total number of breached in current results, which then is divided by the total number of breached in current results, thus yielding the percent of overlapping breached from last result. This provides a quick measure of responsiveness of IT security in fixing breached issues found in the last test.

In one embodiment, if the number of total current tests performed differ more than a certain number from the last set of tests performed, the responsiveness score calculation may include one or more of other measures such as the impact of each test (weight) of each of the test performed or the readiness of the security infrastructure. In another embodiment, some combination of the current responsiveness score and a predicted threat responsiveness score calculated from historical trend (described in the paragraph below) are used to derive the current threat responsiveness, for example an average of the two or some percent based on the weights or other methods, for each of the current and the predicted responsiveness score.

In one embodiment, such responsiveness scores collected over a period of time allows for a historical trend in how IT security team has performed in being responsive to fixing issues between successive runs of security testing or evaluation. In one embodiment, such historical trend can be used to predict the responsiveness of IT security at any given time in future.

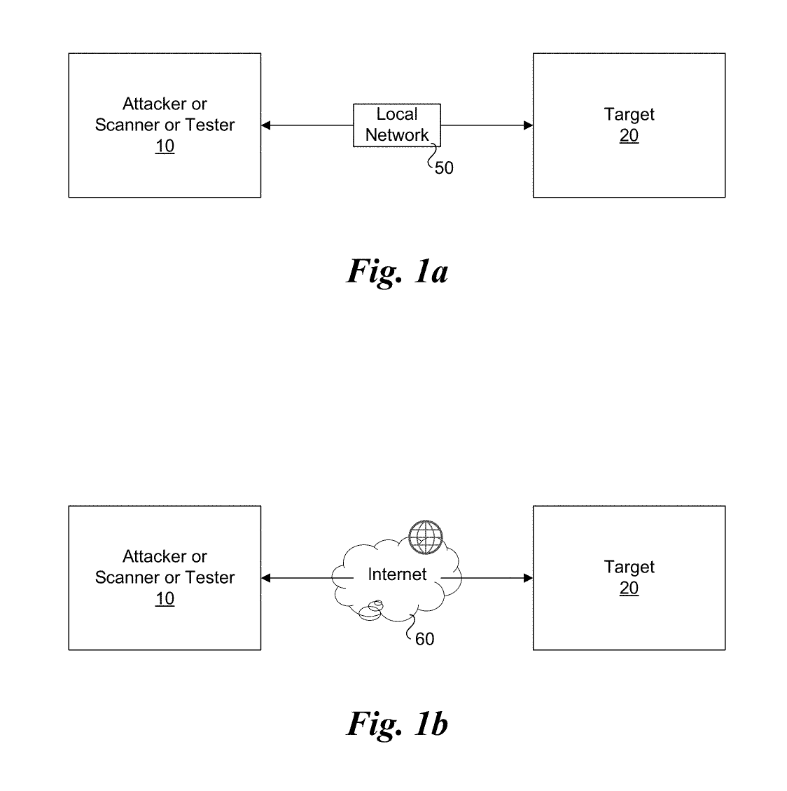

FIG. 1a is a block diagram illustrating a first security testing scheme where one system acts as an attacker, tester or scanner, while another system on the same local network acts as a target. As illustrated, an attacker/tester/scanner 10 is coupled in communication with a target 20 via a local network 50, such as a local company network. Attacker/tester/scanner 20 may have a security testing, attack generation, vulnerability and other threat scanner product installed or may be used by a human as an attacker system. Target 20 may or may not have any software, application or other component installed on it; however, it is being used as a potential target of an attack, testing or scanning. Target 20 can be a single system or multiple systems on the network.

FIG. 1b a block diagram illustrating a second security testing scheme under which the attacker/tester/scanner 10 or human utilizing the attacker/tester/scanner remotely interact with a target 20 via a wide area network such as the Internet 60 to perform security testing and/or evaluation. Under a typical implementation, target 20 will comprise company security infrastructure. Under some embodiments, the remote access may be provided via a secure channel or other secure means such as a VPN.

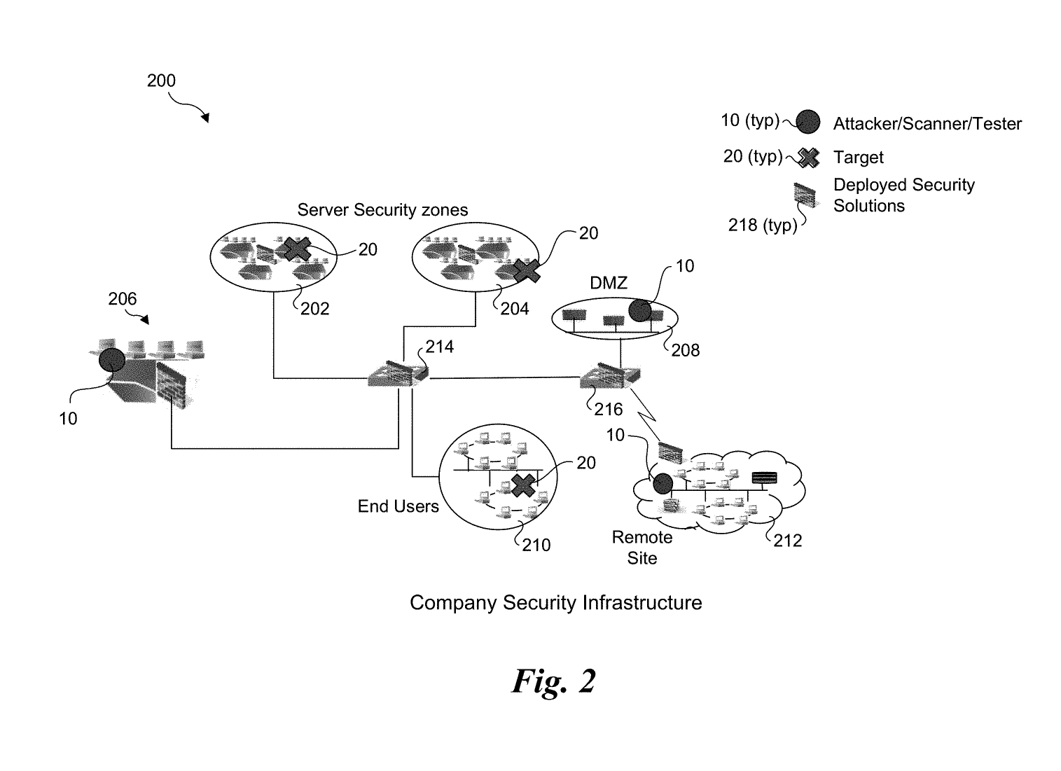

FIG. 2 illustrates a first exemplary deployment of various attacker/tester/scanner systems and various targets in a company network across some or all of the company's different security zones, where various assets of the company are deployed such as application servers, end-user systems, de-militarized zones (DMZ) and even remote sites within a company security infrastructure 200. The illustrated company security infrastructure includes server security zones 202 and 204, application servers 206, a DMZ 208, end users 210, and a remote site 212, which are interconnected with various network infrastructure depicted as switches 214 and 216. Company security infrastructure 200 also includes deployed security solutions 218. Under the deployment shown in FIG. 2, the attackers/scanners/testers 10 and various targets 20 are all on company's own network whether on (a) local site(s) and/or remote site(s).

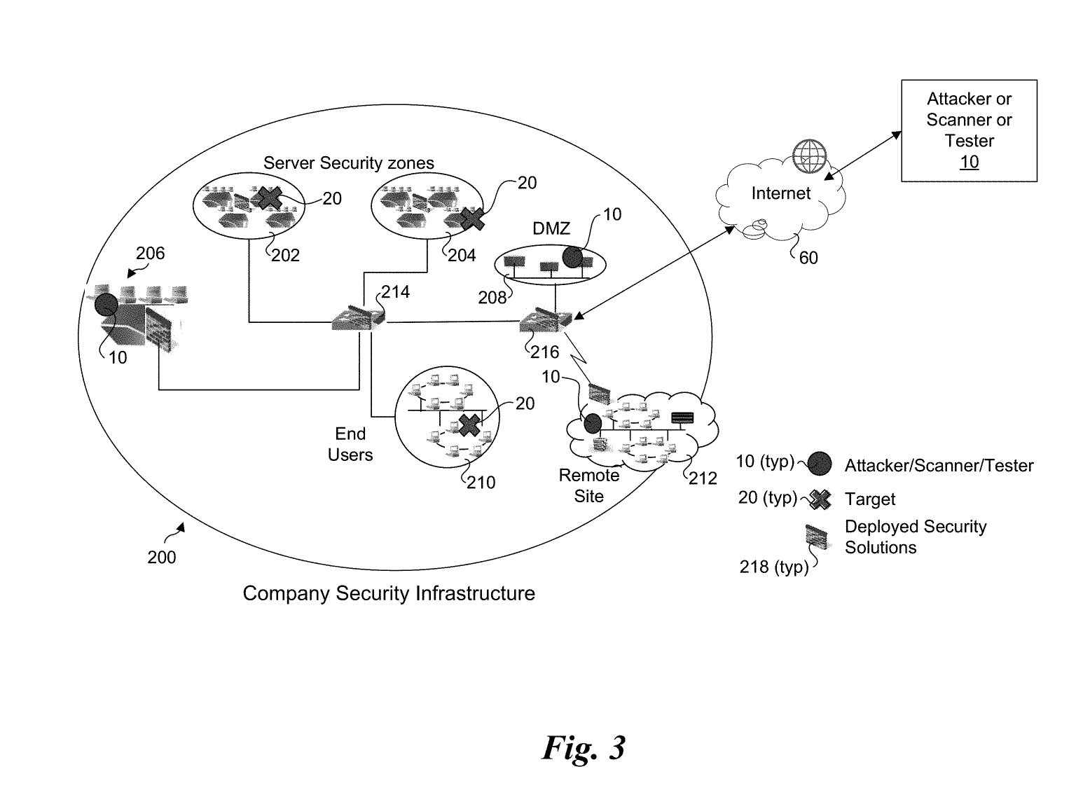

FIG. 3 illustrates a second exemplary deployment of various attacker/tester/scanner systems and various targets in a company network across some or all of the company's different security zones. As shown, attackers/scanners/testers 10 can be local on the company's own network as well as possibly coming from a remote location accessed through Internet 60.

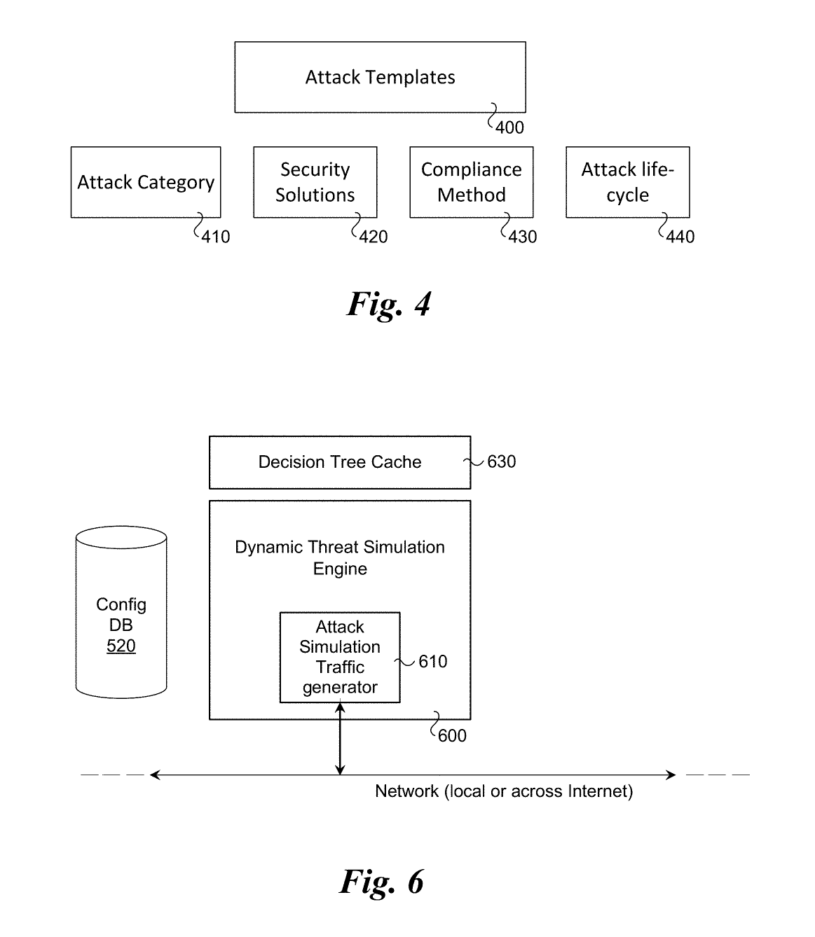

FIG. 4 is a schematic diagram illustrating components of an attack template and classifications, including attack templates 400, attack category 410, security solutions 420, compliance method 430, and attack life-cycle 440. In one embodiment, the attack template and classification may include fields such as:
Attack Name & Description for each attack; Type of Attack by category of attack—for an example can be Firewall Attacks, Intrusion Prevention Attacks, Ransomware, Spyware Transfer, Evasion Techniques etc.; Type of Attack by method or applicable infrastructure component—for an example can be EndPoint Attacks, Web Server Attacks, Host scan, Network Crawler; Malware Attacks, Email Spoofing-Spamming etc.;
Type of Attack by other references—that may be specific to the current attack being simulated; Which Security Solutions should detect and block this attack (i.e. which solutions are impacted)—for an example can be Firewall, Anti-Malware, Data Leakage Prevention, Intrusion Prevention etc.;
Set of Input—are parameters required to simulate the current attack effectively; Expected set of output—are the expected result information after the current attack simulation completes; What stage in attack life-cycle (or cyber-kill-chain) does this apply—for example can be Reconnaissance, Weaponize etc.;
What are the preceding life-cycle (or cyber-kill-chain) stages—is the previous stage of cyber-kill-chain that should precede the current attack; List of potential preceding set of attacks (references)—for example are the attacks that could have result in this current attack being executed next; What is the expected next life-cycle (or cyber-kill-chain) stage—is the stage that follows the current attack if successfully executed;
List of potential next set of attacks (references)—are the list of attacks, as applicable, that can follow the current attack, if successfully executed; List of attack application method and components it may apply to—for example can be network, server, endpoint etc.; and
Attack method type and other relevant info for attack execution—this information can be used to further analyze the required execution of the current attacks; Reference to or Actual attack—for example can point to a method, code, script, binary etc. that can be called to once, multiple times or in succession to execute the current attack.

In one embodiment, attack templates 400 may start with two types of initial classification, one is what type simulation method it uses (e.g., as defined in attack category 410) and potential infrastructure components it targets (e.g., as defined in security solutions 420), and a second is the attack category to determine what stage of attack life-cycle or cyber-kill-chain the attack may apply to. In one embodiment, an attack template may include additional fields beyond described above. In one embodiment, attack templates are created manually, in another, they may be created by a script or scripting language and in yet another embodiment they may be created through other types of automated methods. Generally embodiment attack templates may be created using one or more of the foregoing approaches.

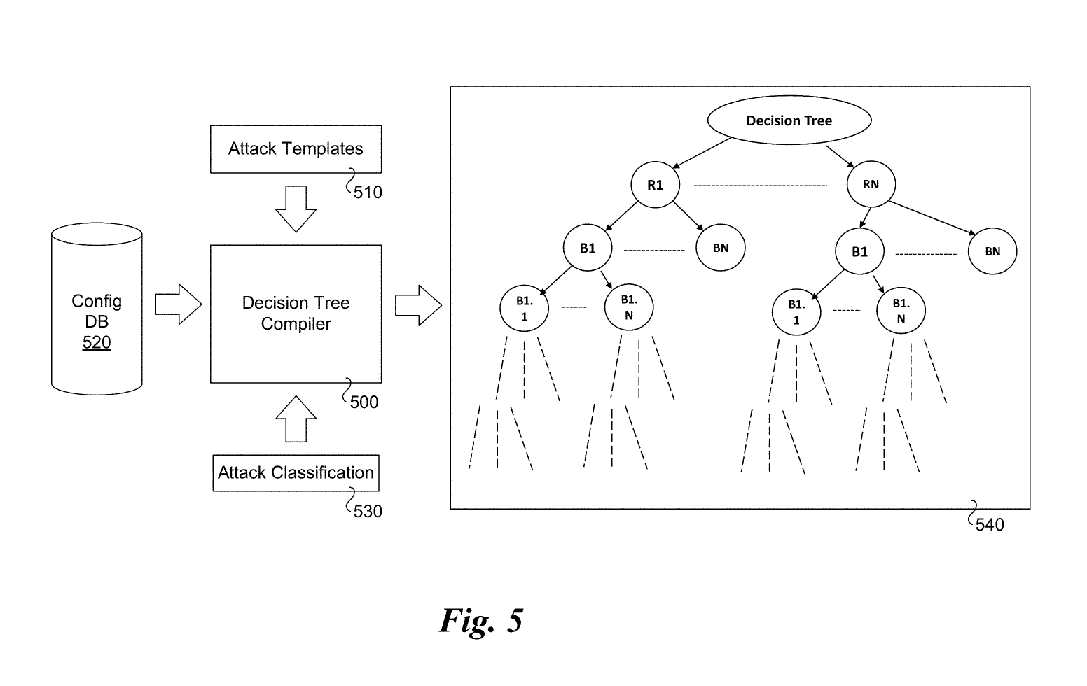

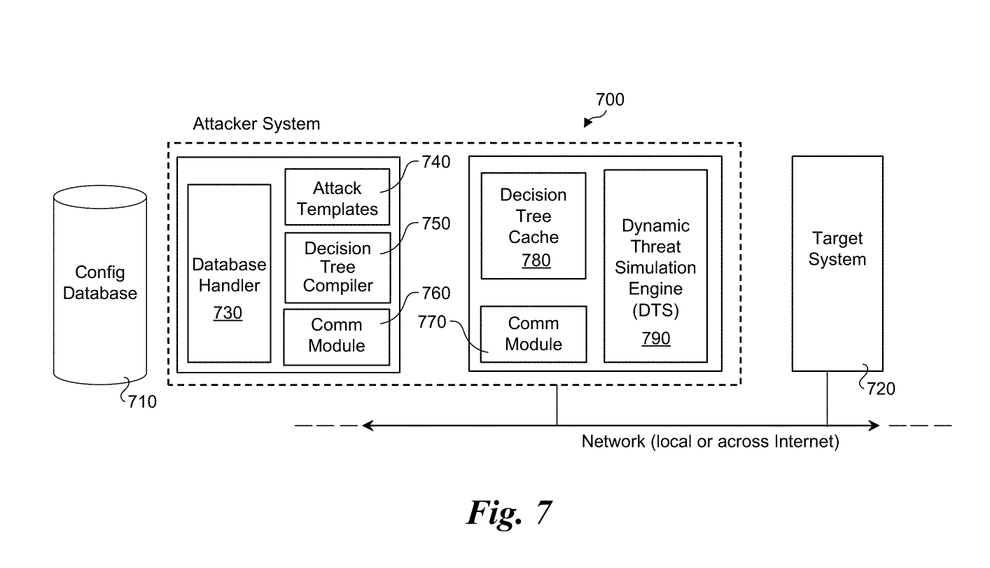

FIG. 5 demonstrates one example embodiment of the stateful decision tree builder or compiler (DT Complier) 500. In this embodiment, DT compiler 500 takes multiple inputs such as configuration information read from a configuration database 520, pertinent attack templates 510 for the current execution of stateful, dynamic attack simulation engine, and template attack classification information 530. In this example embodiment, it then goes through the list of specified templates and creates a decision tree 540 as outlined in FIG. 5. Decision tree 540, for example, can include fields such as attack root nodes, each with multiple sets of branches and sub-branches as applicable, representing attacks that follow one-after-the-other in a sequence, based on different stages of execution and expected results of those attack simulations. In one embodiment, the DT complier 500 can be in form of a separate process. In another, it can be integrated in to a stateful, dynamic, decision tree based, attack simulation engine (DTS engine), such as depicted by DTS engine 600 in FIG. 6. In yet another embodiment, it can be a separate executable or method. In one embodiment, the DT complier 500 can be executed off-line, in another embodiment, it can be executed in-line with the execution of DTS engine 600, and in yet in another embodiment it can be a combination of off-line and in-line execution. In one embodiment, DT Complier 500 may be called upon only once to create the decision tree. In another embodiment it may be called upon multiple times or as often as required.

FIG. 6 illustrates one embodiment of a DTS engine 600. In this embodiment, the DTS Engine 600 utilizes the decision tree generated by the DT Compiler 500 along with the run profile information and configuration to simulate attacks against the intended Target system 20 using an attack simulation traffic generator 610 to measure the effectiveness of deployed security infrastructure in detecting and preventing various types of dynamically executed threats and attack scenarios. DTS engine 600 first connects with Target 20 and provides to Target 20 the details of the Run-profile (the configuration parameters and attacks details to be simulated). Next, using the decision tree generated by DT Compiler 500, the DTS engine goes through each root node and follows through each of the specific, applicable branches of each root node and executes (simulates) the actual attack simulation for each, records the results and compares the expected and actual results to move to the next applicable node of the branch. Once all potential attacks of a branch are executed, it moves to the next applicable branch of the root node and so forth, until all applicable branches in each of the root nodes are executed. It then collects results observed by Target 20 and consolidates them with its own results to create the final results and records them in to a configuration database 520 with the run-profile and result config information for future reference and for user delivery. As further illustrated, a decision tree cache 630 may be used to cache information relating to the decision tree to enhance performance.

FIG. 7 is an illustration of a block diagram of the components of one embodiment of an Attacker System 700. In this embodiment, Attacker 700 includes components such as a Database Handler 730 and a DT Compiler 750. Database handler 730 communicates with a configuration database 710 using a Comm module 760 to retrieve configuration information such as Attack Templates 740 and store results and perform other relevant database-related tasks. DT Compiler 750 is called as required to generate an attack Decision Tree that is stored in Decision Tree Cache 780. DTS Engine 790 then utilizes information in the Decision Tree to generate attacks against a Target System 720 using a Comm module 770 on the given network, which, for example can be a local area network, wide area network or the Internet.

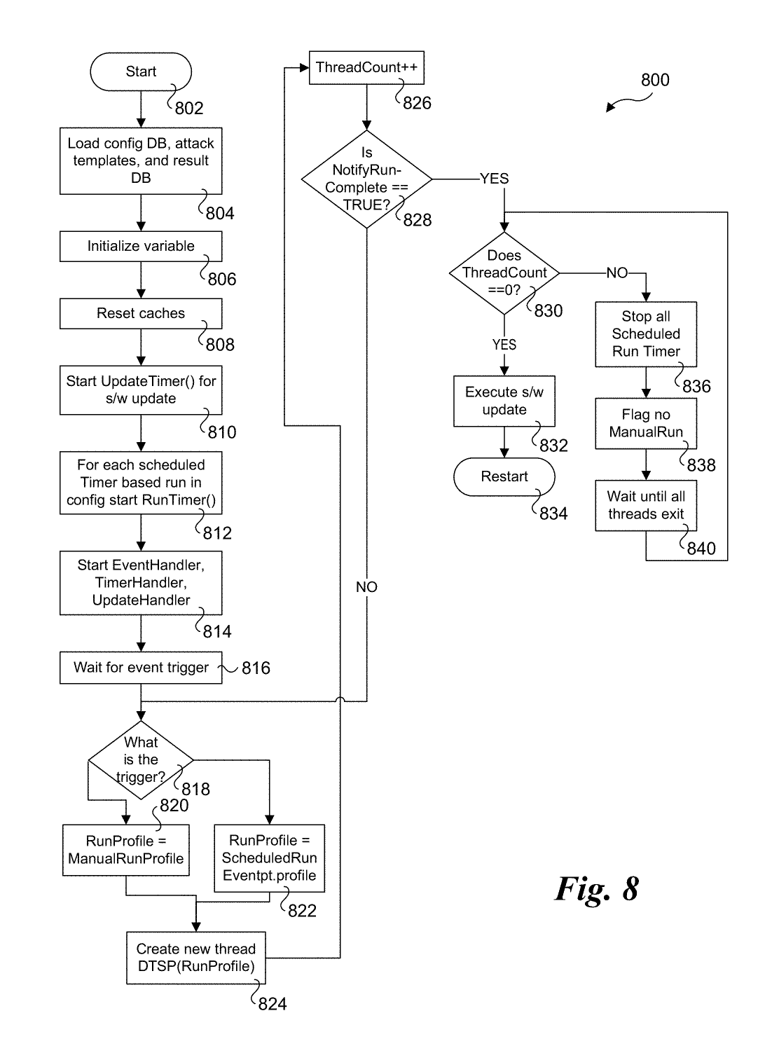

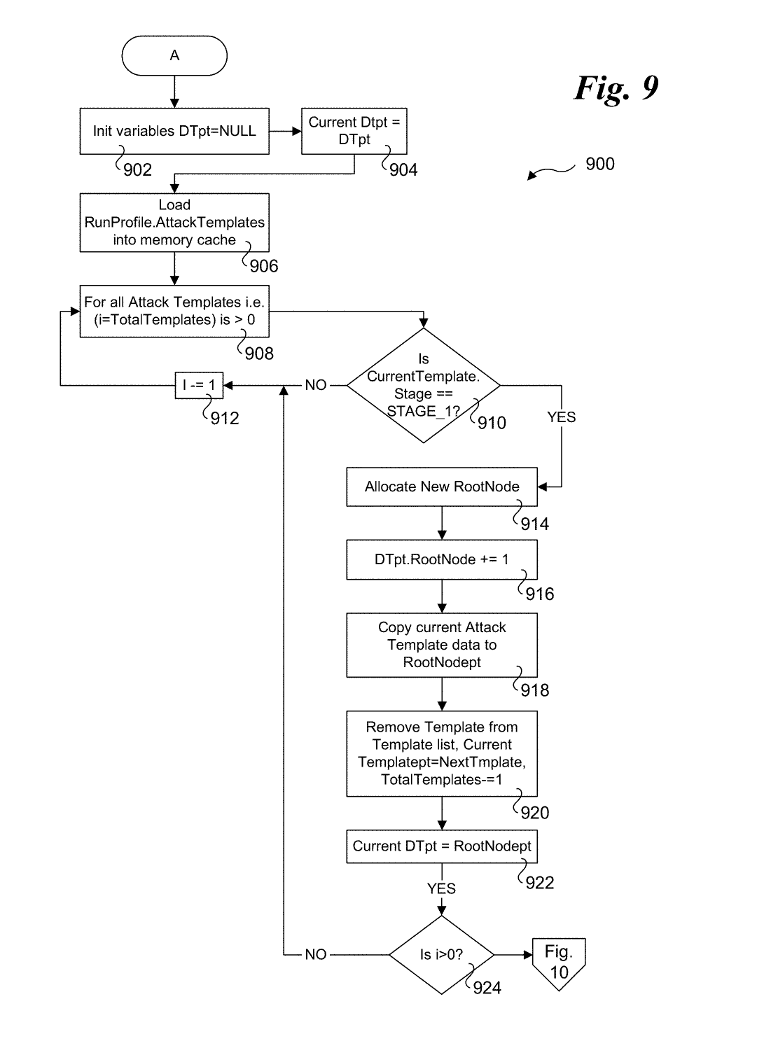

FIG. 8 shows a flowchart 800 illustrating operations and logic implemented by one embodiment of a main program. The main program utilizes multiple process threads to execute multiple instances of DTS engine 600 for enhanced performance and to potentially provide simultaneous attack simulations against multiple Target systems 10. The logical flow of the main program and its modules herein describe one possible implementation and is meant just as such, i.e., a logical flow and not as a ready-to-implement complete program. Therefore, certain programmatic details such as, for example, communication services between attacker and target and command-and-control (as applicable), console-based-events handling, handling of timer or thread execution race conditions etc. are not illustrated in FIG. 8; however, it will be understood by those having skill in the art that such programmatic details would be implemented in an actual system.

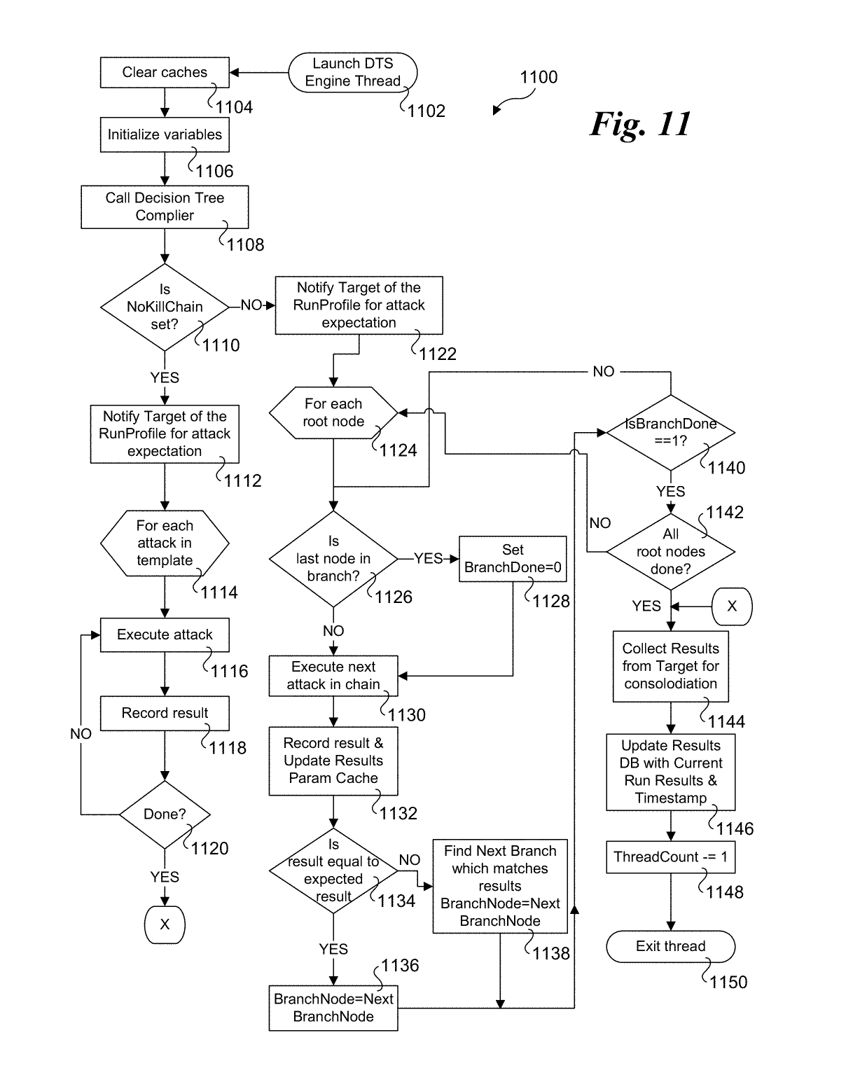

The process begins in a start block 802 followed by a block 804 that loads the configuration and result database tables entries (pointers) as well as the attack templates in Attack Simulation database. Variables are initialized in a block 806 and applicable caches are reset in a block 808. Some of these variables and caches are used and shared with the DTS engine threads, as illustrated below in FIG. 11.

In a block 810, a timer for checking and downloading software and attack database updates on a periodic basis is started. The timer is employed to ensure all software components including attack templates remain current with the distributed software updates.

The process then goes through each of the scheduled simulation runs and their respective timer profiles to schedule timers for each of them, as depicted in a block 812. Once all timers are scheduled, block 814 starts event handler threads including EventHandler, TimerHandler and UpdateHandler threads. Each of those threats handle their specific events respectively, including timer expiry and console driven events, as described below in further detail.

In a block 816 the main process waits for a specific event to occur, as detected by an event trigger. The wait is broken when either a console-driven event occurs (e.g., a manual run of Attack simulation) or when one of the scheduled run timers expire. In a decision block 818 a determination is made to the type of event trigger that is detected. As depicted in a block 820, if the event is manual-run, then the current RunProfile from the event data is retrieved. If the event is timer-run, then the timer event data has the pointer to the RunProfile, as depicted in a block 822. The RunProfile contains pertinent information about the required attack simulation for this run. It includes information such as a) which system is acting as the attacker and which as the target; b) specific categories of attacks which need to be simulated; c) what type of simulation needs to be run (i.e. network, endpoint, server, application) as well as d) whether it's a stateful simulation or straight simulation which executes attack contained in the profile one by one, without the stateful follow-through; and other relevant information. In one embodiment, the RunProfile is used throughout the program including DTS Engine, DT Compiler and other modules.

In a block 824 a new DTS Engine thread for the current run of the attack simulations is created. The DTS Engine is provided the pointer to the current RunProfile as a base configuration for simulating attack during this specific run. In block 826 a TotalThread count is incremented for house-keeping purposes.

A decision block 828 checks to see if the NotifyRunComplete variable is set to TRUE, which indicates there is a pending software update which has been downloaded. If the variable is TRUE, the main program suspends starting any new DTS Engine threads until all currently running threads finish their execution, at which point the software updates including new attack templates can be handled and incorporated in to the process data. This logic is illustrated in blocks 830, 832, 834, 836, 838, and 840.

As depicted by the loop connected to decision block 830, the process loops until the thread count is 0, indicating all threads have completed execution. If the answer to decision block 830 is NO (one or more threads are currently running), the logic proceeds to stop all scheduled run time threads in block 836, flag no ManualRun in block 838, and wait until all threads exit in block 840. After all threads have exited, the process loops back to decision block 830, which no detects the thread count is 0, causing the logic to proceed to execute the software update in block 832 to incorporate new updates in to the configuration and attack template databases. The main process is then restarted in restart block 834. The main program runs indefinitely until either the system is rebooted or a manual kill signal is sent to end the process.

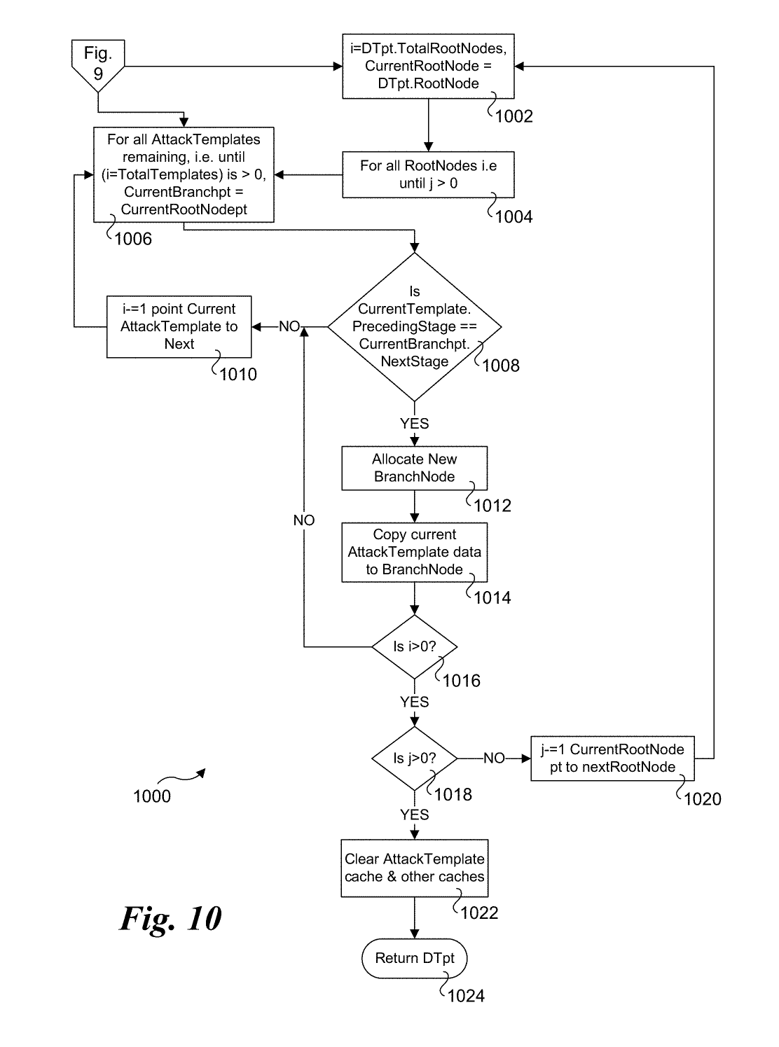

FIG. 9 and FIG. 10 respectively show flowcharts 900 and 1000 corresponding to the logical flow for the decision tree compiler (DT Compiler) module, according to one embodiment. The DT Compiler utilizes the attack templates from the current RunProfile and creates a logical decision tree for the DTS engine to execute for the stateful attack simulation based on dynamically received results of each attack simulation. The logic required to build decision tree nodes, branches and sub-branches is fairly self-explanatory to one knowledgeable in the art of software and information security, once the decision tree architecture is understood as represented in FIG. 5.

In blocks 902 and 904 variables and caches including the attack template cache, the DTpt and CurrentDtpt variables are initialized. Block 906 loads the attack templates pointers contained in the current RunProfile to the cache for faster execution.

The next set of blocks 908 through 924 go through each of the attack templates once to determine which set of attack simulations make up the root nodes of each the decision tree . (See discussion of FIG. 5 above for more details on decision tree nodes called root nodes and branch nodes). Block 908 is the start of the loop for identifying and creating root nodes of the decision tree, while decision block 910 checks if the current stack template simulates a stage 1 (i.e., reconnaissance type of) attack. If the answer to decision block 910 is not, the logic proceeds to decrement I in a block 912 and returns to block 908 to evaluate the next attack template.

If the current template simulates a stage 1 attack, the logic proceeds to allocate a root node memory in block 914, and increment the root node count in the main decision tree handle in block 916. Block 918 is to copy attack template details in to the root node contained in the decision tree cache. Block 920 removes the template from the current attack template list since it contains root node attack simulation and will not be executed multiple times. Block 922 links the node to the next root node pointer in the decision tree. In decision block 924 a determination is made to whether all of templates have been checked, and if so, the logic continues to perform the operations and logic shown in flowchart 1000 of FIG. 10. If all the templates have not been checked, the answer to decision block 924 will be NO, and the logic will decrement I in block 912 and return to block 908 to process the next attack template.

The logic depicted in blocks 1002, 1004 and 1006 in flowchart 1000 determines whether to continue down the same branch, start a new branch or go to the next root node. Blocks 1006 through 1018 comprise a loop that goes through each attack template once for creating branches under the current root node. These operations check whether the template applies as a logical next-in-line based on various parameters including preceding stage, next (following) stage, expected results from current attack to match next attack templates expected input etc. Based on these comparisons, the branch is either continued to be built or another sub-branch to begin. Once all attack templates are exhausted, then the root node counter is decremented and start the same loop with the next root node. Once the branches and sub-branches for all root nodes are built, the answer to decision block 1018 will be YES, and the logic will proceed to a block 1022 which clears out local caches and other variables and return the newly created decision tree in return block 1024, represented by DTpt to the calling process.

FIG. 11 shows a flowchart 1000 illustrating the DTS Engine thread's logical flow, according to one embodiment. The DTS Engine primarily performs two tasks; one is to execute the DT Compiler at run-time to create the decision tree from the given RunProfile and related attack templates, and the second is to go through the newly decision tree for this attack simulation run and generate specific attacks based on received results of each attack simulation. To that end, the DTS engine only requires RunProfile as the input and once completed, generates the output in form of the consolidated results of the current run of attack simulations.

In a start block 1102 a DTS engine thread is launched, with block 1104 and 1106 being configured to clear and initialize caches and variables. Block 1108 calls the DT Compiler (FIGS. 9 and 10) to generate the attack decision tree for this simulation run. Once the decision tree is ready, a determination is made in a decision block 1110 to see if this simulation run requires stateful execution based on the decision tree and received results of executed attack simulations at each node, or just a straight one-after-the-other attack execution. If it's the latter, which corresponds to NoKillChain being set, the logic proceeds to blocks 112 through 1120, then step 1112 through step 1120 to execute (block 1116) each of the attacks contained in the attack templates provided through the current RunProfile configuration and record the results (block 1118). First, however, the Target needs to be notified of all attacks which are going to be run (in block 1112), so it can expect those attacks to measure results in terms of the successful (breached) or failed (blocked) attacks. Once all attacks are completed, as determined by a YES result for decision block 1120, execution continues to the end of the thread for consolidation of results both locally observed and collected from the Target, as depicted in blocks 1144 through 1150.

If the answer to decision block 1110 is NO, the logic proceeds to notify the Target of the RunProfile for the expected attack in block 1122. Blocks 1124 onwards are the crux of the DTS engine, i.e., if the attack simulations need to be statefully executed based on received results from each stage, then the DTS engine performs the decision tree traversal accordingly. Decision block 1126 is used to cause the process block to go through each of the root nodes and then follow through their subsequent branches to simulate specific attacks one by one following results received through each simulation. Once the last node in the branch is processed, the logic proceeds to set BranchDone =0, and then proceeds to find the next root node in block 1130, otherwise continue down the current branch. Block 1132 is configured to simulate the attack, and then decision block 1134 is to record the result in the result parameter cache and block 1136 is to compare the result to expected results. If the results match, then the logic continues down the branch or else finds the next branch that matches received result from the current simulation, as depicted in block 1138.

Once the branch is complete, the logic moves on to the next root node and the process is repeated for that root node. In this manner, the entire tree is executed based on root nodes and their subsequent branches (attacks) simulated based on received results vs. the expected ones. Once all root nodes are exhausted then the decision tree walk-trough is complete and so are all the relevant attack simulations for this specific run of the DTS engine. The operations in block 1144 through are then to implemented to collect result from the Target (block 1144) and consolidate those with the observed results locally at the Attacker and then update the results database accordingly (block 1146). The DTS engine thread then decrements the total ThreadCount in block 1150 and the thread exits in end block 1150.

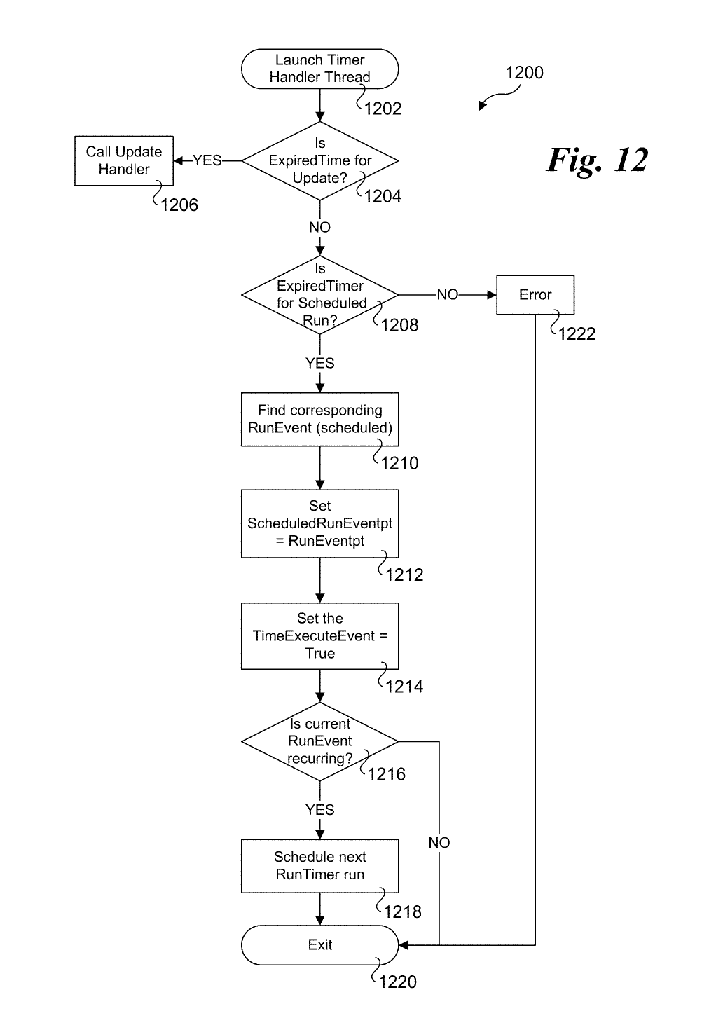

FIG. 12 shows a flowchart 1200 illustrating operations and logic implemented in one embodiment of the timer handler for the main process. A timer handler is launched in a start block 1202 in response to a call to handle timer expiry events. When the timer handler is invoked by the system, it receives a pointer to the timer event which expired. In a decision block 1204 the handler checks to determine whether the update timer that expired. If so, then an update handler function is called, as depicted in a block 1206.

In a decision block 1208 a determined is made to whether the timer event is a scheduled DTS run timer; if not, an error has occurred, and the timer handler reports the error in a block 1222 and then exits in an exit block 1220. If the timer event is a scheduled DTS run timer, the answer to decision block 1208 is YES, and the logic proceeds to btep 1210 to find the current event. In block 1212 the ScheduledRunEventpt pointer is set to the current run event so the main process can find the associated RunProfile and other relevant configuration to execute a DTS Engine run. In block 1214 the event variable is set to TRUE for the main process to identify it is the timer for scheduled run which expired. In a decision block 1216 a determination is made to whether a current running event is a recurring timer, and, if so, block 1218 reschedules the timer for the next run and then exits the timer handler at end block 1220. Otherwise, if the answer to decision block 1216 is NO, block 218 is skipped and the timer handler exits at end block 1220.

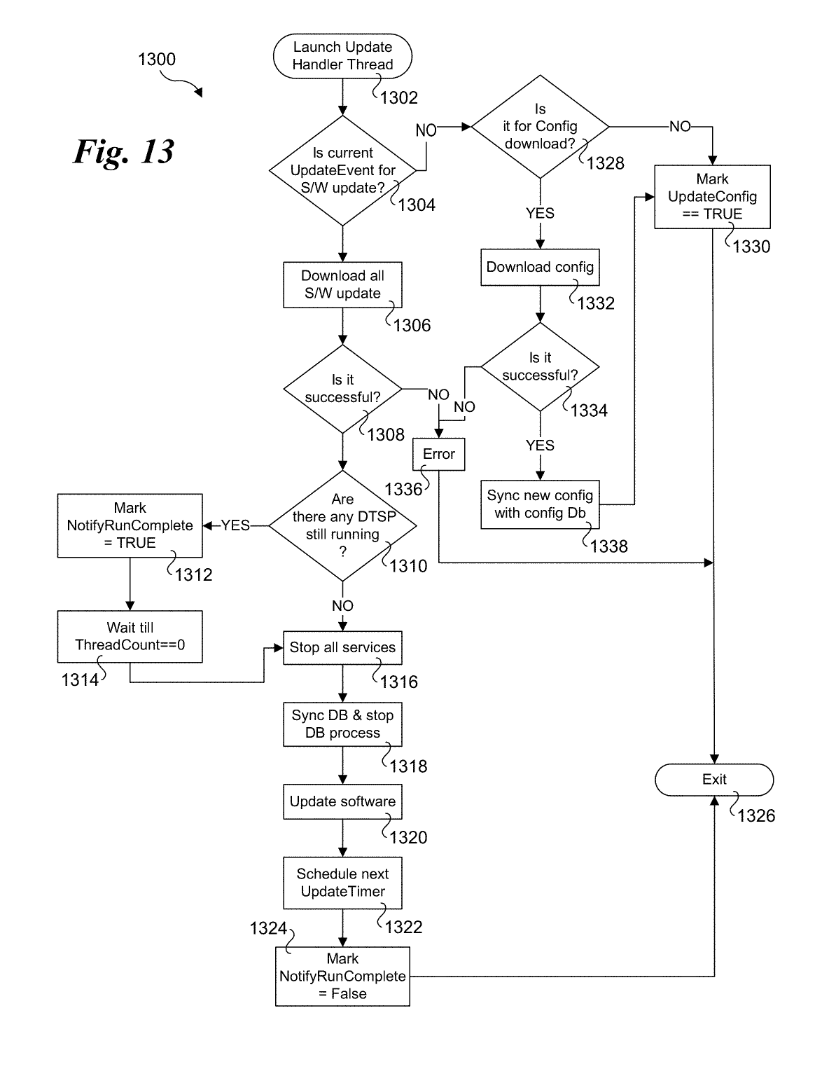

FIG. 13 shows a flowchart 1300 illustrating the logical flow of one embodiment of the update event handler function. The update event handler is usually called either by the timer handler, if the scheduled update timer expires, or by the console event handler, when a configuration update event occurs from the console, either of which results in an event handler thread being launched in a start block 1302. In a decision block 1304, a determination is made to whether the update handler needs to check for a software (S/W) update or handle the configuration update. If the current event is a software update, the logic proceeds to a block 1306 which checks with the update server and download all software updates that may be pending. If software update download fails, as determined in a decision block 1308, then an error is reported in a block 1336 and the process exits in end block 1326.

If software update download is successful, the logic proceeds to a decision block 1310 in which a determination is made whether there are any DTS Engine threads running. Software updates cannot be installed and updated until all currently running threads exit. If there are DTS Engine threads running, then the ThreadCount will be greater than zero, yielding a YES result for decision block 1310, which leads to blocks 1312 and 1314 which are used to notify the main process to not start any new DTS Engine threads and wait until all threads exit, as indicated by the ThreadCount being 0 in block 1314 Once all threads have exited, either as a result of waiting in block 1314 or a NO result for decision block 1310, the logic proceeds to a block 1316 in which all services are stopped. In a block 1318, the database is synchronize with all pending results or other updates and then end the database service. The software is than updated in a block 1320. In a block 1322, the software update timer is rescheduled for the next software update. Finally, in a block 1324 the NotifyRunComplete parameter is set to FALSE so the main process can continue executing DTS Engine threads, and the process exits in exit block 1326.

If the current UpdateEvent is to update the configuration, the answer to decision block 1304 is NO, and the logic will proceed to perform the operations in blocks 1328 through 1338 to handle the configuration update. In decision block 1328 a determination is made to whether the configuration update is for a configuration download. If it is, the configuration download is performed in a block 1332, and a determination is made in a decision block 1334 to whether the configuration download is successful. If so, the logic proceeds to a block 1334 to sync with the configuration database which contains configuration and RunProfiles with relevant information. The logic then proceeds to a block 1336, in which the global variable UpdateConfig is marked as TRUE so the main process can reload the config database for subsequent DTS Engine runs. The handler then exits at exit block 1326. As before, if the configuration download is not successful, the logic proceeds to generate an error in error block 1336 and then exits in exit block 1326.

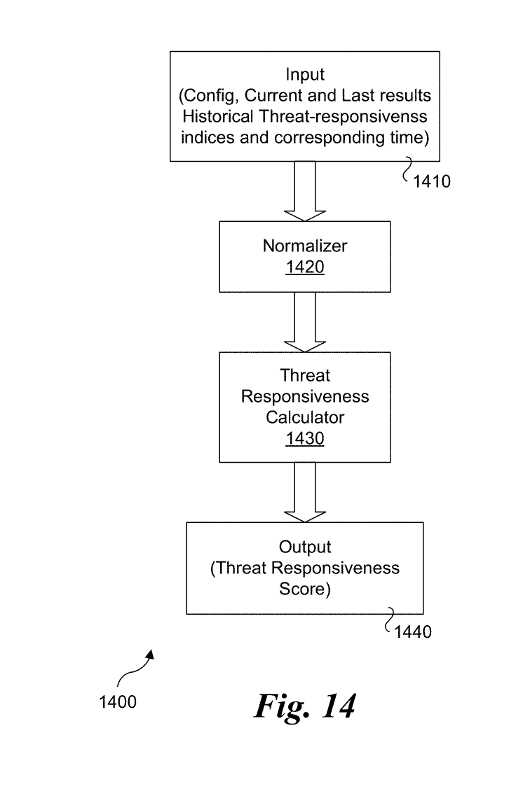

FIG. 14 shows a flow diagram 1400 illustrating input, output, and processing operations performed by a normalizer and threat responsiveness calculator according to one embodiment. The process receives an input 1410 including test/scan/attack configuration information, current and last results, historical threat responsiveness indices and/or alternatively a time stamp for which to potentially provide a predicted value for the responsiveness at that time. Input 1410 is first processed by a normalizer 1420, which performs normalization operations described below. The output of normalizer 1420 is received as an input by a threat responsiveness calculator 1430, which outputs a threat responsive score 1440.

FIG. 14 is an illustration of method and system according to one or more embodiments of this invention showing a simplified diagram of two major components normalizer and threat responsiveness calculator. FIG. 14 shows that the input for the method and system are the test/scan/attack configuration as well as the current and last results of such testing or alternatively a time stamp for which to potentially provide a predicted value for the responsiveness at that time. The output of the method and system is the calculated threat responsiveness score.

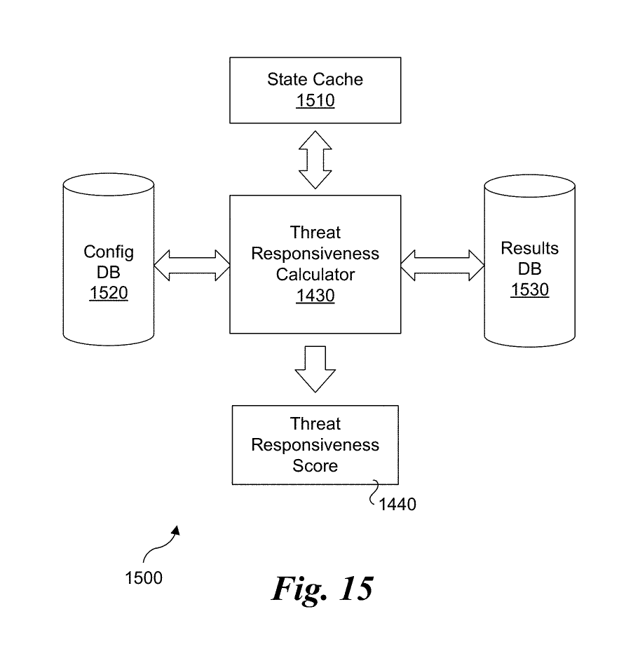

FIG. 15 is a combined block and flow diagram 1500 illustrating further details of the threat responsiveness calculator 1430 of FIG. 14. As shown, threat responsiveness calculator 1430 utilizes a state cache 1510 to store local data during its calculations, while interfacing with a results database (DB) 1530 and configuration database 1520. Generally, configuration database 1520 may store various test/attack/scan scenarios with their normalized identifiers, as described in further detail below. Results database 1530 is used to store test results, including the last and current test results as well as historical data of various responsiveness scores calculated at various points in time.

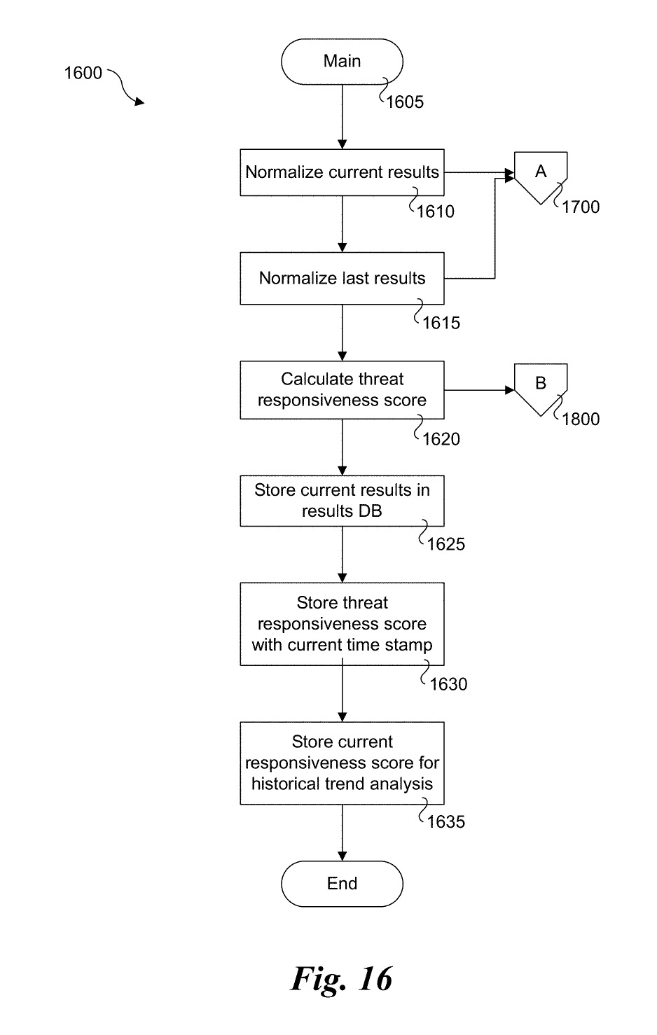

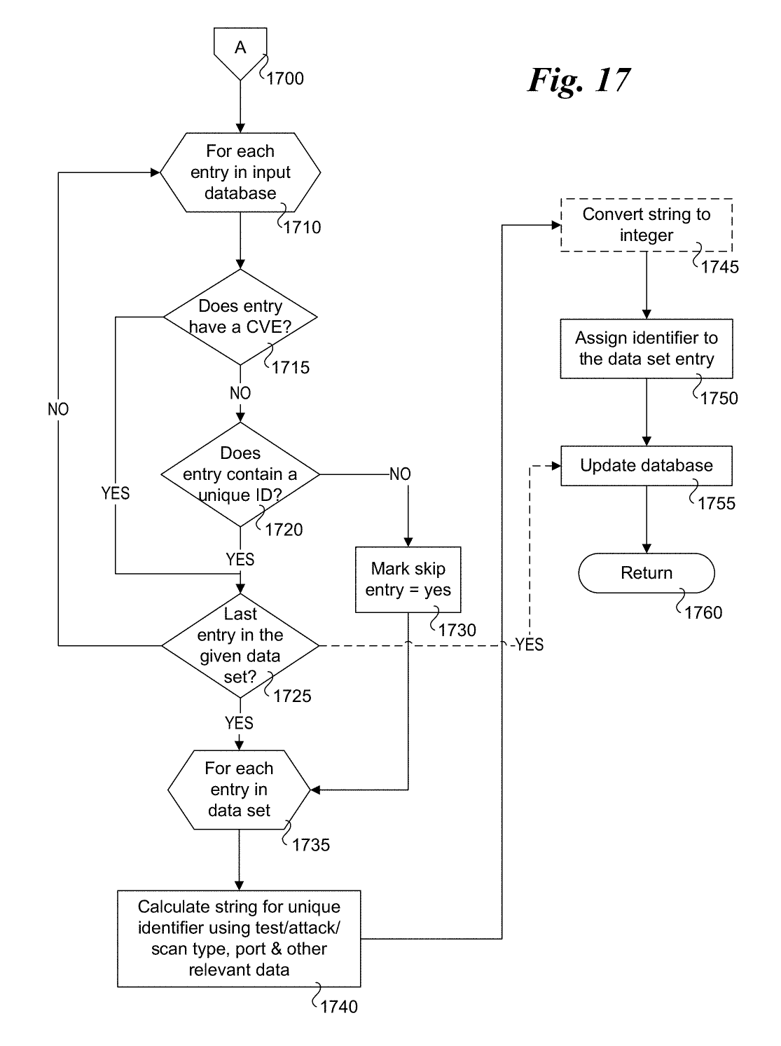

FIG. 16 shows a flowchart 1600 illustrating the high-level logical flow of the main program, according to one embodiment. The process begins in start block 1605 in which the main program is loaded (or otherwise called if previously loaded), various variables, caches, and parameters are initialized, various database tables are read to initialize the process. In blocks 1610 and 1615, the current and last results are respectively normalized, if they are not already normalized. Database tables are created for last result, current result, config used in calculation for the current result and the historical data of responsiveness scores with their corresponding time-stamp of calculation date. In one embodiment, the configuration database 1520 is normalized, then the two current and last result database tables in results database 1530 are normalized by calling the normalization module 800, whose operations and logic are shown in FIG. 17 and described below.

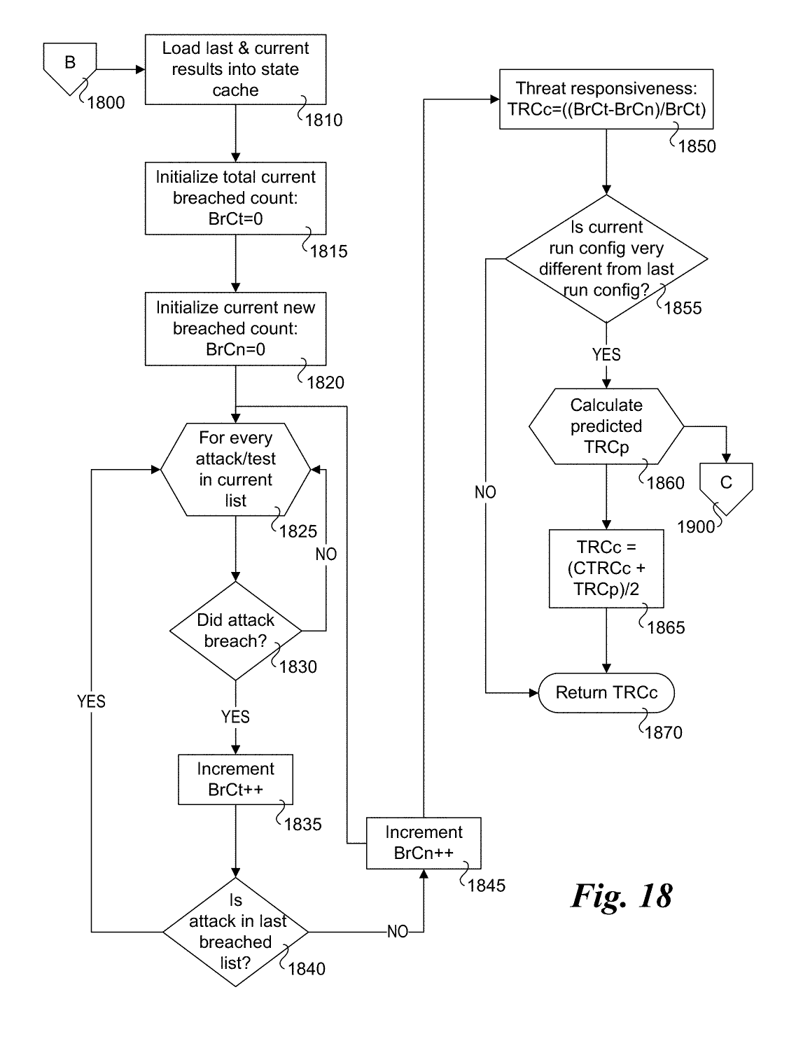

As shown in a block 1620, once the normalization is complete, the responsiveness score for the current time period is calculated using the responsiveness calculator engine using process 1800 shown in FIG. 18. The computed current results are then stored in results database 1530, as shown in a block 1625. Once the operations of block 1625 are completed, the last results are deleted in a block 1630, and the current results are marked as the last results for next set of responsiveness calculations. In a block 1635, the computed current responsiveness score is stored for historical trend analysis in results database 1530. Once all of the above operations are completed and threat responsiveness score is computed, the main program ends, as depicted by an end block 1640.

FIG. 17 shows operations and logic for implementing a normalization procedure, according to one embodiment. Generally, the normalization process illustrated in FIG. 17 can be done as part of the responsiveness calculations or independently as its own program. This embodiment of a normalization procedure takes a data set, such as results, configuration database or other type of similar data set, as input, then normalizes each entry as required and returns the normalized version of the given data set. In one embodiment, this procedure goes through the given input data set twice, first to ensure that entries do not already contain unique entry identifier such as CVE or other unique identifier and second time to create unique identifiers for each entry in the data set and update the data set accordingly. Under another approach, if all the entries in a given data set already have a unique identifier, such as CVE or other unique identifier, those existing unique identifiers are used.

As depicted by the loop including block 1710 and decision blocks 1715, 1720, and 1725, each entry in the given input data set is processed to identify if it has an existing identifier, such as a CVE in decision block 1715 or another type of unique identifier in block 1720. If, for a given data set, the logic reaches decision block 1725 and it is determined the last entry has bee processed, then the data set either includes a CVE for each entry or another unique identifier for each entry. Accordingly, in one embodiment, the CVEs or other unique identifiers are used without creating separate unique identifies, as depicted by the dashed path labeled YES from decision block 1725 to a block 1755 in which the database is updated. Under another embodiment, a unique identifier is calculated for each entry, regardless of whether it already has a CVEs or other unique identifiers. In this case, after it is determined the last entry in a data set is processed, the logic proceeds to a block 1735. For each entries in a given data set that does not have a unique identifier, the answer to decision block 1720 will be NO, and the logic will proceed to a block 1730 in which the entry is marked to be skipped.

As depicted by block 1735, the operations in blocks 1740, 1745, and 1750, are performed for each entry in the data set. In block 1740 a string is calculated to be used as a unique identifier for the entry using one or more relevant attributes. For example, such relevant attributes may include TCP/IP or UDP/IP port numbers, severity of impact, remediation and other relevant parameters. Using the relevant attributes as an input, a unique identifier string is then calculated using different techniques such as for example uni-coding, MD5 hashing and other possible methods. In an optional block 1745, the unique string may be converted to an integer. In some cases, the string may also be left as is, as a unique identifier, with optional block 1745 being skipped. In block 1750 the newly created unique identifier is assigned to the current data set entry. Once the operations of blocks 1740, 1745, and 1750 have been performed, the database is updated with the unique identifiers created for those entries in block 1755 before returning in end block 1760.

FIG. 18 is a logical flow representation of one embodiment of how to calculate responsiveness score from the given current and last result databases (data sets). This embodiment of the procedure takes current and last results databases as input and returns calculated readiness score for the current period, as the output. In a block 1810, the last and current results are loaded into the state cache for a faster processing access. In a block 1815 a Total breached count in Current results (BrCt) is initialized, while in a block 1820 a New breached attack count in current results (BrCn) is initialized.

As depicted by the loop including blocks 1825 and 1835 and decision blocks 1830 and 1840, each entry in the current results data set is evaluated to calculates how many total attacks actually breached for the current results list (BrCt) and the breached results are compared with the last result data set to calculate the new attacks breached (BrCn). In further detail, each attack or test in the current list is checked to determine if a given attack/test results in a breach (decision block 1830), and if so the BrCt is incremented (block 1835), otherwise block 1835 is skipped for the given attack/test. In decision block 1840 a determination is made to whether the attack that breached was in the last result set list. If not, the attack/test result is new, and BrCn in incremented in a block 1845.

After all of the entries have been processed, the logic proceeds to a block 1850 to calculate the Responsiveness score. In the illustrated embodiment the Responsiveness score TRCc==((BrCt−BrCn)/BrCt), i.e., TRCc is calculated as a difference in total breached attacks and new breached attacks in the current result data set, divided by the total breached attacks in the current result data set. Optionally, the Responsiveness score can then be converted in to a percentage. At this stage, the Responsiveness score TRCc may be returned as is, or may be further refined in blocks 1855, 1860, and 1865.

In decision block 1855, the current run configuration is compared to the last run configuration to see, if from the last run to current run, if there were too many new attacks tested, rather than similar attack configuration as the last result run with few newer additions. If the last configuration that was tested differed too much from the last run configuration, then it can potentially yield an inaccurate measurement for responsiveness. In one embodiment, the procedure compares the current configuration data sets entries (unique identifiers) one by one with the configuration of the last run data set, counts the different number of entries, and if they are more than threshold number, consider the difference to be high enough. If the last and current results sets are too different, the answer to decision block 1855 is YES and the logic proceeds to a block 1860 which uses another procedure C illustrated in FIG. 10 and described below to predict a threat responsiveness score TRCp from historical trend data. Next, in block 1865 the threat responsiveness is calculated as TRCc=(CTRCc+TRCp)/2, that is the average of the current responsiveness and the predicted responsiveness for this timestamp, and this value of TRCc is returned in end block 1870 rather than the TRCc value determined in block 1850.

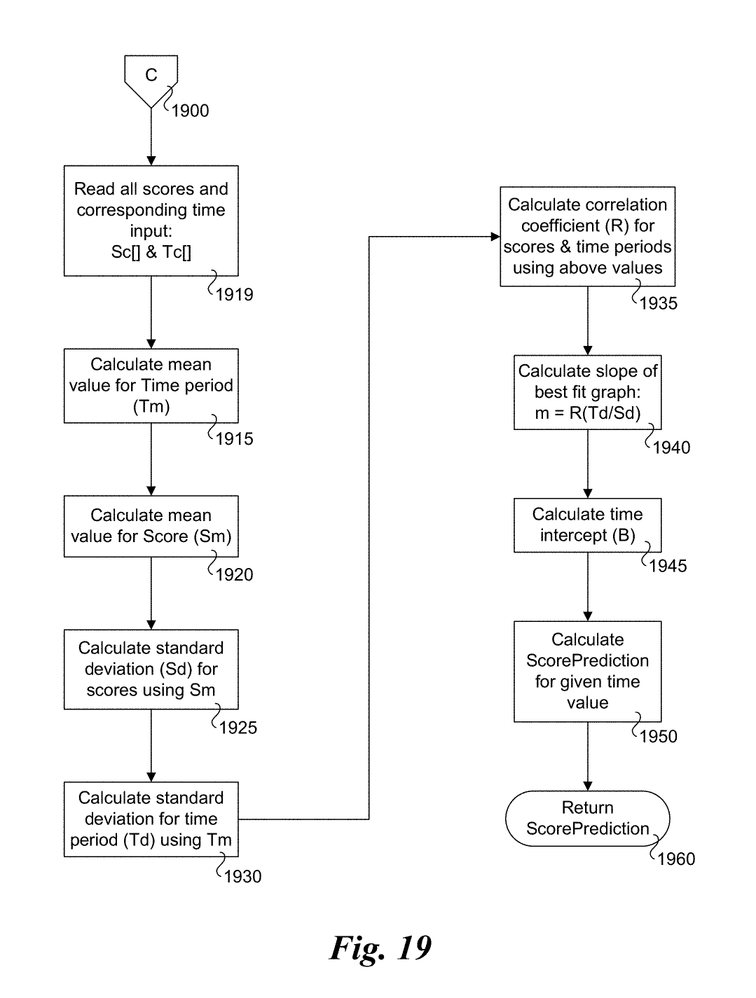

FIG. 19 shows operations corresponding to one embodiment of a procedure to predict a threat responsiveness score for a future time based on historical data of a set of threat responsiveness scores and their corresponding time of calculation. This embodiment of the procedure takes these two datasets as input along with a timestamp (as an example current time) and returns a predicted threat responsiveness score for that timestamp. The procedure utilizes standard mathematical calculations such as mean, standard deviation and others to build a prediction engine.

The process begins in a block 1910 in which the historical datasets for the threat responsiveness scores (Sc) and their corresponding time of calculation (Tc) are read. In block 1915 the mean value for the timestamp (Tm) is calculated, while the mean value for the threat responsiveness score (Sm) is calculated in a block 1920. In a block 1925 the standard deviation (Sd) for the threat responsiveness score is calculated using Sc and Sm for the score, while the standard deviation for the time period (Td) is calculated in a block 1930. In block 1935 the correlation co-efficient (R) is calculated using the above values of scores and time. In a block 1940 the slope m of the best fit line for the given data sets using Tc, Td and R is calculated as m=R(Td/Sd). In block 1945 the given timestamp value is used to calculate the time intercept (B). In a block 1950 the predicted score (ScorePrediction) for a given time value is calculated, and that ScorePrediction value returned as the predicted score value in return block 1960.

Exemplary Implementation Environment

In accordance with some embodiments, it is envisioned that aspects of the method and systems described herein may be implemented in a data center and/or server farm environment. Typically, the servers used in data centers and server farms comprise arrayed server configurations such as rack-based servers or blade servers. These servers are interconnected in communication via various network provisions, such as partitioning sets of servers into LANs with appropriate switching and routing facilities between the LANs to form a private Intranet. For example, cloud hosting facilities may typically employ large data centers with a multitude of servers. Some enterprises may operate similar configurations either on-site or offsite through either their own hosted service or using a third-party service such as Amazon Web Services (AWS) or Microsoft Azure.

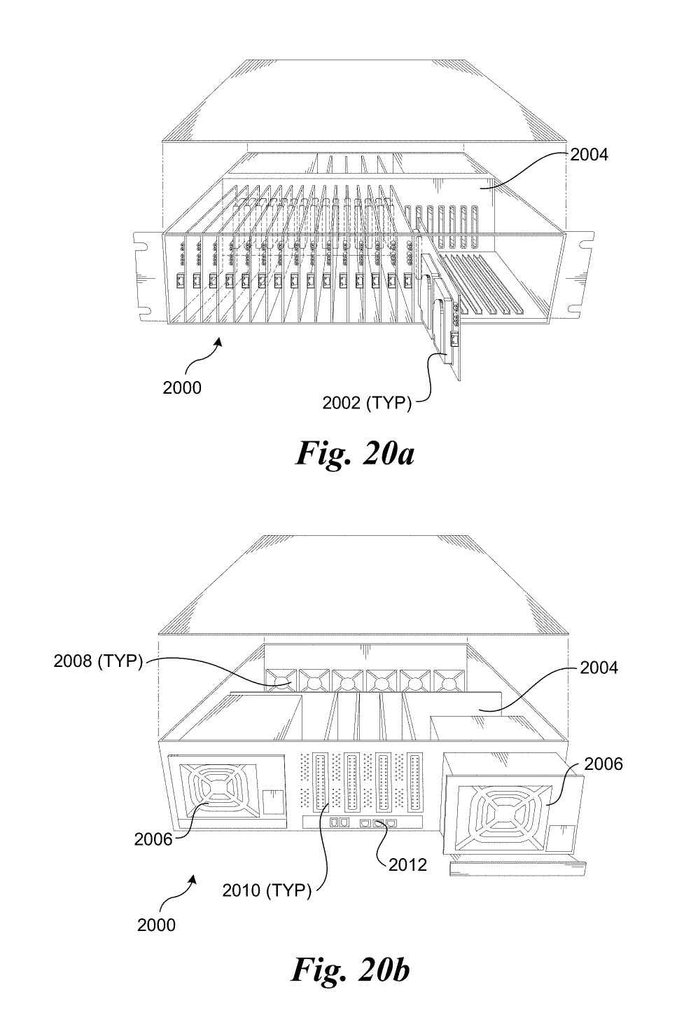

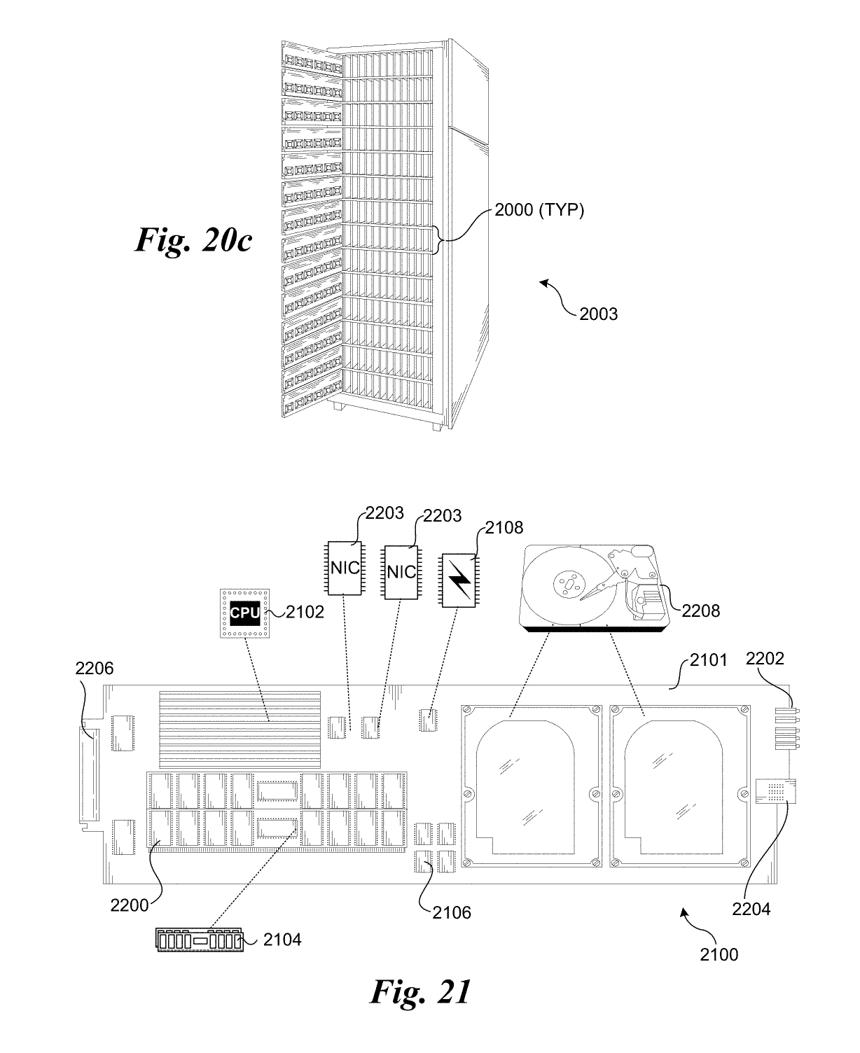

As an overview, typical blade server components and systems are shown in FIGS. 20a-c, and 21. Under a typical configuration, a rack-mounted chassis 2000 is employed to provide power and communication functions for a plurality of server blades (i.e., blades) 2002, each of which occupies a corresponding slot. (It is noted that all slots in a chassis do not need to be occupied.) In turn, one or more chassis 2000 may be installed in a blade server rack 2003 shown in FIG. 20c. Each blade is coupled to an interface plane 2004 (i.e., a backplane or mid-plane) upon installation via one or more mating connectors. Typically, the interface plane will include a plurality of respective mating connectors that provide power and communication signals to the blades. Under current practices, many interface planes provide “hot-swapping” functionality—that is, blades can be added or removed (“hot-swapped”) on the fly, without taking the entire chassis down through appropriate power and data signal buffering.

A typical mid-plane interface plane configuration is shown in FIGS. 20a and 20b. The backside of interface plane 2004 is coupled to one or more power supplies 2006. Oftentimes, the power supplies are redundant and hot-swappable, being coupled to appropriate power planes and conditioning circuitry to enable continued operation in the event of a power supply failure. In an optional configuration, an array of power supplies may be used to supply power to an entire rack of blades, wherein there is not a one-to-one power supply-to-chassis correspondence. A plurality of cooling fans 2008 are employed to draw air through the chassis to cool the server blades.

An important feature required of all blade servers is the ability to communicate externally with other IT infrastructure. This is typically facilitated via one or more network connect cards 2010, each of which is coupled to interface plane 2004. Generally, a network connect card may include a physical interface comprising a plurality of network port connections (e.g., RJ-45 ports), or may comprise a high-density connector designed to directly connect to a network device, such as a network switch, hub, or router.

Blade servers usually provide some type of management interface for managing operations of the individual blades. This may generally be facilitated by a built-in network or communication channel or channels. For example, one or more buses for facilitating a “private” or “management” network and appropriate switching may be built into the interface plane, or a private network may be implemented through closely-coupled network cabling and a network. Optionally, the switching and other management functionality may be provided by a management switch card 2012 that is coupled to the backside or frontside of the interface plane. As yet another option, a management or configuration server may be employed to manage blade activities, wherein communications are handled via standard computer networking infrastructure, for example, Ethernet.

With reference to FIG. 21, further details of an exemplary blade 2100 are shown. As discussed above, each blade comprises a separate computing platform that is configured to perform server-type functions, i.e., is a “server on a card.” Accordingly, each blade includes components common to conventional servers, including a main printed circuit board (main board) 2101 providing internal wiring (i.e., buses) for coupling appropriate integrated circuits (ICs) and other components mounted to the board. These components include one or more processors (e.g., multi-core processors) 2102 coupled to system memory 2104 (e.g., some form of Dynamic Random Access Memory (DRAM), such as DRAM DIMMs, RDIMMs and/or NVDIMMs), cache memory 2106 (e.g., SDRAM), and a firmware storage device 2108 (e.g., flash memory). A NIC (network interface controller) chip 2110 is provided for supporting conventional network communication functions, such as to support communication between a blade and external network infrastructure. Other illustrated components include status LED (light-emitting diodes) 2112, one or more NICs 2113 coupled to a set of RJ-45 console ports 2114 (only one of which is shown for simplicity), and an interface plane connector 2116. Additional components include various passive components (i.e., resistors, capacitors), power conditioning components, and peripheral device connectors.

Generally, each blade 2100 may also provide on-board storage. This is typically facilitated via one or more built-in disk controllers and corresponding connectors to which one or more disk drives 2118 are coupled. For example, typical disk controllers include SATA controllers, SCSI controllers, and the like. As an option, the disk drives may be housed separate from the blades in the same or a separate rack, such as might be the case when a network-attached storage (NAS) appliance or backend storage sub-system that is employed for storing large volumes of data. Generally, the disk drives may be solid state drives, (SSDs), magnetic drives and/or optical drives).

In a typical data center deployment, network switching elements comprise rack-mounted equipment, such as a Top-of-Rack (ToR) switch or similar switching elements may be implemented as stand-alone components occupying a 1U, 2U, or 4U slot in the rack. Optionally, a network switching element may be implemented use one or more server blades. In addition to conventional network communication components, such as Ethernet and InfiniBand, other communication facilities, such as to support communication over a wired or optical fabric, may also be provided (not shown).

In addition to the blade server configuration illustrated in FIG. 20a-20c and 21, other type of servers may be implemented, including both standalone servers and rack-mounted servers. For example, 1U, 2U and 4U servers or server chassis housing server modules or the like may be used. In some embodiments, rack and server components in accordance with INTEL® Corporations Rack Scale Design may be implemented. In addition, other types of rack-based architecture may be used, including both standardized and proprietary architectures.

In each system shown in a figure, the elements in some cases may each have a same reference number or a different reference number to suggest that the elements represented could be different and/or similar. However, an element may be flexible enough to have different implementations and work with some or all of the systems shown or described herein. The various elements shown in the figures may be the same or different. Which one is referred to as a first element and which is called a second element is arbitrary.

In the description and claims, the terms “coupled” and “connected,” along with their derivatives, may be used. It should be understood that these terms are not intended as synonyms for each other. Rather, in particular embodiments, “connected” may be used to indicate that two or more elements are in direct physical or electrical contact with each other. “Coupled” may mean that two or more elements are in direct physical or electrical contact. However, “coupled” may also mean that two or more elements are not in direct contact with each other, but yet still co-operate or interact with each other. Additionally, “communicatively coupled” means that two or more elements that may or may not be in direct contact with each other, are enabled to communicate with each other. For example, if component A is connected to component B, which in turn is connected to component C, component A may be communicatively coupled to component C using component B as an intermediary component.

An embodiment is an implementation or example of the inventions. Reference in the specification to “an embodiment,” “one embodiment,” “some embodiments,” or “other embodiments” means that a particular feature, structure, or characteristic described in connection with the embodiments is included in at least some embodiments, but not necessarily all embodiments, of the inventions. The various appearances “an embodiment,” “one embodiment,” or “some embodiments” are not necessarily all referring to the same embodiments.

Not all components, features, structures, characteristics, etc. described and illustrated herein need be included in a particular embodiment or embodiments. If the specification states a component, feature, structure, or characteristic “may”, “might”, “can” or “could” be included, for example, that particular component, feature, structure, or characteristic is not required to be included. If the specification or claim refers to “a” or “an” element, that does not mean there is only one of the element. If the specification or claims refer to “an additional” element, that does not preclude there being more than one of the additional element.

An algorithm is here, and generally, considered to be a self-consistent sequence of acts or operations leading to a desired result. These include physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers or the like. It should be understood, however, that all of these and similar terms are to be associated with the appropriate physical quantities and are merely convenient labels applied to these quantities.

As discussed above, various aspects of the embodiments herein may be facilitated by corresponding software and/or firmware components and applications, such as software and/or firmware executed on a processor or the like. Thus, embodiments of this invention may be used as or to support a software program, software modules, firmware, and/or distributed software executed upon some form of processor, processing core or a one or more virtual machines running on a processor or core or otherwise implemented or realized upon or within a non-transitory computer-readable or machine-readable storage medium. Generally, the software programs and/or modules may be configured to be executed on a single host machine, such as a server, or may be distributed and executed on multiple host machines. A non-transitory computer-readable or machine-readable storage medium includes any mechanism for storing or transmitting information in a form readable by a machine (e.g., a computer). For example, a non-transitory computer-readable or machine-readable storage medium includes any mechanism that provides (i.e., stores and/or transmits) information in a form accessible by a computer or computing machine (e.g., computing device, electronic system, etc.), such as recordable/non-recordable media (e.g., read only memory (ROM), random access memory (RAM), magnetic disk storage media, optical storage media, flash memory devices, etc.). The content may be directly executable (“object” or “executable” form), source code, or difference code (“delta” or “patch” code). A non-transitory computer-readable or machine-readable storage medium may also include a storage or database from which content can be downloaded. The non-transitory computer-readable or machine-readable storage medium may also include a device or product having content stored thereon at a time of sale or delivery. Thus, delivering a device with stored content, or offering content for download over a communication medium may be understood as providing an article of manufacture comprising a non-transitory computer-readable or machine-readable storage medium with such content described herein.

Various components referred to above as processes, servers, or tools described herein may be a means for performing the functions described. The operations and functions performed by various components described herein may be implemented by software running on a processing element, via embedded hardware or the like, or any combination of hardware and software. Such components may be implemented as software modules, hardware modules, special-purpose hardware (e.g., application specific hardware, ASICs, DSPs, etc.), embedded controllers, hardwired circuitry, hardware logic, etc. Software content (e.g., data, instructions, configuration information, etc.) may be provided via an article of manufacture including non-transitory computer-readable or machine-readable storage medium, which provides content that represents instructions that can be executed. The content may result in a computer performing various functions/operations described herein. It will be further understood, that the software for implementing various aspects of the embodiments described and illustrated herein may be executed on physical hardware, such as machine code execute on processor cores in multicore processors, as well as executed using virtual machines or containers running on underlying physical hardware through use of Type-1 Hypervisors, Type-2 Hypervisors, Virtual Machine Monitors (VMMs), Docker, etc.

In some of the illustrated embodiments, multiple databases are depicted. However, it will be understood by those skilled in the art that the use of multiple databases is merely illustrative and non-limiting, as the functionality of the databases described herein may be implemented using either a single database or multiple databases. Moreover, such a database or databases may be implemented using one or more database instances running on a single host machine, or may be implemented in a distributed manner through facilities provided by multiple host machines.

As used herein, a list of items joined by the term “at least one of” can mean any combination of the listed terms. For example, the phrase “at least one of A, B or C” can mean A; B; C; A and B; A and C; B and C; or A, B and C.

The above description of illustrated embodiments of the invention, including what is described in the Abstract, is not intended to be exhaustive or to limit the invention to the precise forms disclosed. While specific embodiments of, and examples for, the invention are described herein for illustrative purposes, various equivalent modifications are possible within the scope of the invention, as those skilled in the relevant art will recognize.

These modifications can be made to the invention in light of the above detailed description. The terms used in the following claims should not be construed to limit the invention to the specific embodiments disclosed in the specification and the drawings. Rather, the scope of the invention is to be determined entirely by the following claims, which are to be construed in accordance with established doctrines of claim interpretation.

What is claimed is:

1. A computer implemented method for measuring Information Technology (IT) responsiveness on threat management and infrastructure security, comprising:
obtaining security evaluation results for two successive evaluation periods, the security evaluation results including a current data set and a last data set, each of the current data set and the last data set including a plurality of entries, each entry including information designating a respective attack or test and a breached or blocked result for that attack or test;
normalizing the plurality of entries in each of the current and last data set such that each entry has a unique identifier;
comparing entries in the current data set to entries in the last data set based on the respective attack or test designated for entries in the current data set and last data set to determine differences in breached and blocked results for the two successive evaluation periods; and
calculating an IT responsiveness score as a function of the differences that are determined,
wherein each of the obtaining, normalizing, comparing, and calculating operations are performed using at least one computer.
